(19) United States
(12) Patent Application Publication
(10) Pub. No.: US 2008/0302939 A1
(43) Pub. Date: Dec. 11, 2008

(54) Container Holder

(76) Inventor: Wen-Tsung Su, Dou-Liou (TW)

Correspondence Address: LIN & ASSOCIATES INTELLECTUAL PROPERTY, INC., P.O. BOX 2339, SARATOGA, CA, 95070-0339, US

(21) Appl. No.: 11/779,278

(22) Filed: Jul. 18, 2007

(30) Foreign Application Priority Data
Jun. 6, 2007 (TW) 096120297

(51) Int. Cl. A47G 23/02; B67C 9/00

(52) U.S. Cl. 248/311.3

(57) ABSTRACT

A container holder includes a plate body, a base provided at a bottom end of the plate body, and a supporting member extended from a surface of the plate body and located above a spaced-apart distance from the base. The supporting member is a U-shaped sheet, and two supporting pieces of the U-shaped supporting member are parallel to each other and a space is defined between the two supporting pieces. The supporting member can hold a container in an inverted manner, and a liquid collector is placed at the base for collecting the liquid flowing out of the container.

### BACKGROUND OF THE INVENTION

1. Field of the Invention

The present invention relates to a holder for use in supporting a container or a bottle, in which the container can be fixed thereon upside down, for ease of completely using the liquid in the container.

2. The Prior Arts

Generally, viscous liquid, such as skin care lotions and shampoos, stored in a container or a bottle is not easy to flow out of the container due to their viscosity. When the liquid will be used up, the container should be put upside down for a period of time to wait the residual liquid flowing out of the container for use. Therefore, in general, users simply close a mouth of the container with a cap and then put the container on a plane surface in an inverted manner to let the residual liquid flow out to the mouth of the container. Then, the liquid can be easily extracted out for use upon opening the cap.

However, because some container caps were designed to have screw threads or a straw, there still have the following problems when using the above-mentioned method.

(1) If the quantity of the residual liquid is greater than the cap capacity, the liquid may overflow from the cap, thereby causing the waste of the liquid.

(2) The liquid which accumulates in the screw threads is not easy to be effectively extracted out for use.

(3) Moreover, the cap with a straw generally has less capacity to collect the liquid, and the design of the straw may block the liquid from extracting out.

(4) Also, owing that a top surface of some caps is designed to be not a planar surface, it is hard for these containers to be stood on a plane surface in an inverted manner. Therefore, a supporting device may be required to hold the containers to prevent them from falling down.

Thus, it is desired to provide a container holder for holding a container in an inverted manner for ease of completely using the liquid in the container.

### SUMMARY OF THE INVENTION

A primary objective of the present invention is to provide a container holder which can securely hold a container in an inverted manner and thus let the liquid flow out of the container completely, so that the liquid in the container can be completely used up.

In order to achieve the above objective, a container holder in accordance with the present invention includes a plate body, a base provided at a bottom end of the plate body, and a supporting member extended from a surface of the plate body and located above a spaced-apart distance from the base. The supporting member is a U-shaped sheet, and two supporting pieces of the U-shaped supporting member are parallel to each other and a space is defined between the two supporting pieces. The supporting member can hold a container in an inverted manner, and a liquid collector is placed at the base for collecting the liquid flowing out of the container.

Accordingly, in accordance with the present invention, the liquid in the container can timely and completely flow out for use. The waste of the liquid can be reduced and the cost can be effectively saved. Besides, users do not need to handhold the container in an inverted manner for a period of time to wait the liquid flowing out of the container when in use.

### BRIEF DESCRIPTION OF THE DRAWINGS

The present invention will be apparent to those skilled in the art by reading the following detailed description of the preferred embodiments thereof, with reference to the attached drawings, in which:

FIG. 1 is a perspective view showing a container holder in accordance with a preferred embodiment of the present invention;

FIG. 2 is a schematic view showing that a container is fixed on the container holder of the present invention; and

FIG. 3 is a perspective view showing a container holder in accordance with another preferred embodiment of the present invention.

### DETAILED DESCRIPTION OF THE PREFERRED EMBODIMENT

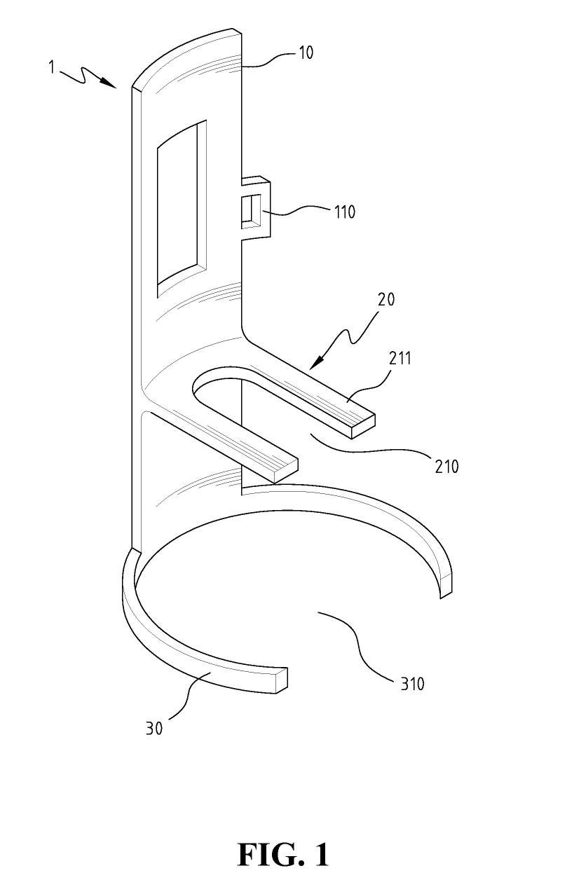

With reference to FIG. 1, a container holder 1 in accordance with a preferred embodiment of the present invention comprises a plate body 10, a supporting member 20, and a base 30.

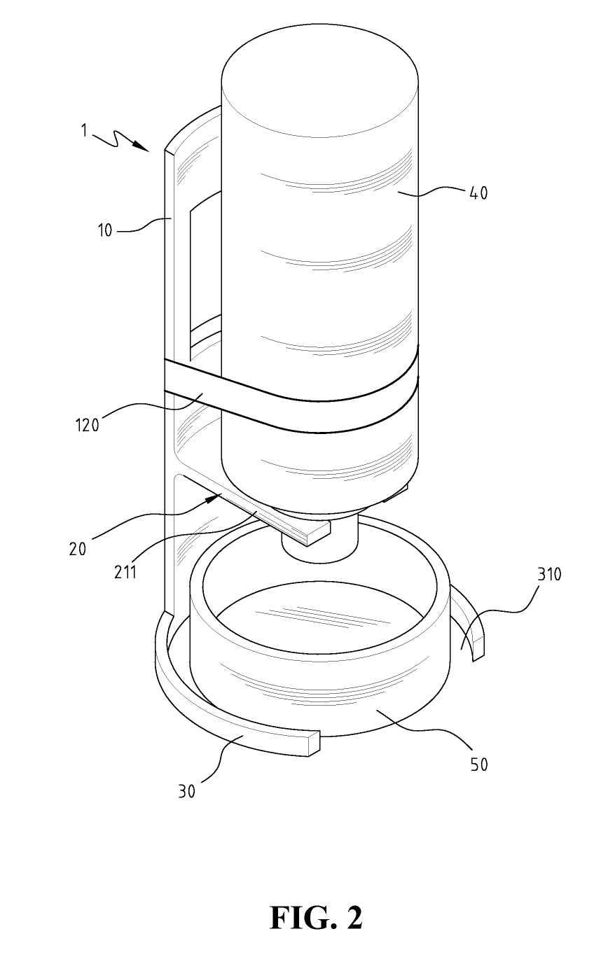

The plate body 10 is of strip-shaped with a transverse arc, and the base 30 is provided at a bottom end of the plate body 10 for stably standing on a plane surface. In this embodiment, the base 30 has two arc members which extends in transverse from both sides of the bottom end of the plate body 10, respectively, and define an opening 310 at a center of the base 30 for placing a liquid collector 50 (see FIG. 2), so that the liquid flowing out of the container 40 can be collected in the liquid collector 50. Moreover, the base 30 is made of the materials with high density, so that the container holder 1 can be stably placed on a plane surface without falling down.

The supporting member 20 is a U-shaped sheet, which is extended from a surface of the plate body 10 and located above a spaced-apart distance from the base 30 for allowing the liquid collector 50 to place therebetween. Furthermore, two supporting pieces 211 of the U-shaped supporting member 20 are parallel to each other, and a space 210 is defined between the two supporting pieces 211. The shoulder of the container 40 can be held by the supporting pieces 211, and the head of the container 40 can pass through the space 210 of the supporting member 20. Accordingly, the container 40 can be supported on the container holder 1.

Besides, a clamp 110 is provided at a side of the plate body 10 above the supporting member 20. Referring to FIG. 2, an elastic band 120 in combination with the clamp 10 is used to securely fix the container 40 on the container holder 1.

With reference to FIG. 1 and FIG. 2, the length of the plate body 10 is defined according to the length of the container 40, so that the container 40 can be securely fixed on the container holder 1. But the spaced-apart distance between the supporting member 20 and the base 30 just need to be properly defined for allowing the liquid collector 50 to place therebetween, wherein the liquid collector 50 can not contact with the supporting member 20.

Please refer to FIG. 2, which shows a container is held on the container holder in accordance with the preferred embodiment of the present invention. In FIG. 2, the container 40 is placed on the container holder 1 in an inverted manner. The two supporting pieces 211 hold the shoulder of the container 40 and the head of the container 40 passes through the space 210 of the supporting member 20. The liquid collector 50 is placed below the head of the container 40 for collecting the liquid flowing out of the container 40. Also, the elastic band 120 fixes the container 40 and clamps with the clamp 110 (not shown in Figures), so that the container 40 can be securely fixed on the container holder 1.

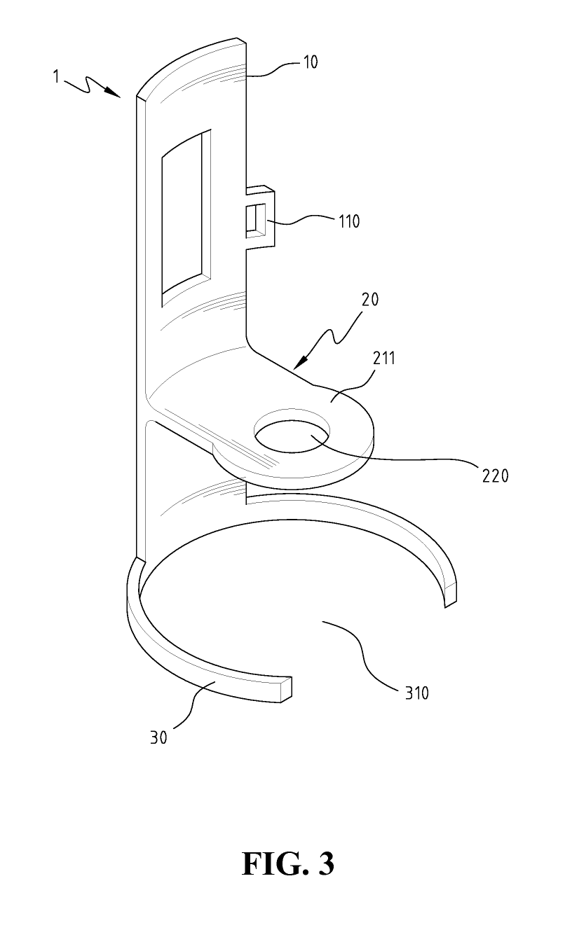

Please refer to FIG. 3, which shows a container holder 1 in accordance with another preferred embodiment of the present invention. The supporting member 20 has an annular piece 211 and a central hole 220 defined on the annular piece 211. The container 40 can be placed on the supporting member 20 in an inverted manner, in which the shoulder of the container 40 is held by the annular piece 211 and the head of the container 40 passes through the central hole 220.

In brief, the present invention can securely hold a container in an inverted manner, so that the liquid in the container 40 can timely and completely flow out for use. Therefore, the waste of the liquid can be reduced and the cost can be effectively saved.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A container holder, comprising:
a plate body;
a base provided at a bottom end of the plate body; and
a supporting member extended from a surface of the plate body and located above a spaced-apart distance from the base.

2. The container holder as claimed in claim 1, wherein a clamp is provided at a side of the plate body between the supporting member and a top end of the plate body.

3. The container holder as claimed in claim 1, wherein the supporting member is a U-shaped sheet, two supporting pieces of the U-shaped supporting member are parallel to each other and a space is defined between the two supporting pieces.

4. The container holder as claimed in claim 1, wherein the supporting member has an annular piece and a central hole defined on the annular piece.
